(19) United States
(12) Patent Application Publication
(10) Pub. No.: US 2024/0033583 A1
(43) Pub. Date: Feb. 1, 2024

(54) Racket Frame and Racket

(71) Applicant: MIZUNO CORPORATION, Osaka (JP)

(72) Inventors: Yohei YAMASHITA, Osaka (JP); Daisuke YASUTOMI, Osaka (JP); Naoya HIGUCHI, Osaka (JP); Takayuki OOTOMO, Osaka (JP)

(21) Appl. No.: 18/226,435

(22) Filed: Jul. 26, 2023

(30) Foreign Application Priority Data
Jul. 29, 2022 (JP) 2022-121624

(51) Int. Cl. A63B 49/08; A63B 49/12; A63B 49/022

(52) U.S. Cl. CPC A63B 49/08; A63B 49/12; A63B 49/022; A63B 2209/02

(57) ABSTRACT

A racket frame includes a face portion having an annular shape in planar view, a grip portion, and a shaft portion connecting the face portion and the grip portion. At least a part of the face portion, the grip portion, and the shaft portion includes a first tubular member. The first tubular member has an inner tubular part, an outer tubular part surrounding the inner tubular part, and a release layer sandwiched between the inner tubular part and the outer tubular part.

### CROSS REFERENCE TO RELATED APPLICATIONS

This nonprovisional application is based on Japanese Patent Application No. 2022-121624 filed on Jul. 29, 2022 with the Japan Patent Office, the entire contents of which are hereby incorporated by reference.

### BACKGROUND OF THE INVENTION

### Field of the Invention

The present invention relates to a racket frame and a racket.

### Description of the Background Art

Conventionally, a racket frame made of a fiber reinforced plastic (hereinafter also referred to as FRP) is known (see, for example, Japanese Patent Laying-Open No. 1-121074). In general, the FRP racket frame is formed by thermally curing a plurality of prepregs laminated on each other, and includes a multilayer body of a plurality of fiber-reinforced resin layers derived from each prepreg. Two fiber-reinforced resin layers adjacent to each other in a laminating direction are bonded to each other without any gap.

### SUMMARY OF THE INVENTION

The racket frame is required to have strength and stiffness to withstand ball hitting. The strength of the racket frame is generally positively correlated with the stiffness. When the strength required for the racket frame is secured, the minimum stiffness required for the racket frame is secured. That is, the stiffness of the racket frame having the required strength is higher than the minimum stiffness required for the racket frame. For this reason, when the stiffness can be reduced while the required strength is secured, repulsive performance of the racket frame can be appropriately designed.

A main object of the present invention is to provide a racket frame and a racket in which the repulsion performance of the racket frame can be appropriately designed while having sufficient strength.

A racket frame according to the present invention includes a face portion having an annular shape in planar view, a grip portion, and a shaft portion connecting the face portion and the grip portion. At least a part of the face portion, the grip portion, and the shaft portion includes a tubular member. In a section orthogonal to an extending direction of the tubular member, the tubular member includes an inner tubular part, an outer tubular part surrounding the inner tubular part, and a release layer sandwiched between the inner tubular part and the outer tubular part.

In the racket frame, only a part of the face portion may include the release layer in an extending direction of the face portion. In the racket frame, when a position of a first part of the face portion farthest from the grip portion in planar view is a 12 o'clock position, the first part of the face portion and a second part at a 3 o'clock position may include the release layer, and a third part of the face portion at a 2 o'clock position may not include the release layer.

In the racket frame, the entire face portion in the extending direction may include the release layer.

In the racket frame, the release layer may be partially disposed in a circumferential direction of the tubular member in a section orthogonal to an extending direction of the face portion.

In the racket frame, the release layer may be disposed over an entire circumference in a circumferential direction of the tubular member in a section orthogonal to an extending direction of the face portion.

In the racket frame, the release layer may exist between a first position at a distance of 20% of a thickness of the tubular member inside from an intermediate position of the tubular member and a second position at a distance of 20% outside from the intermediate position in a thickness direction of the tubular member.

A through-hole penetrating the release layer may be made in the release layer of the racket frame in a thickness direction of the tubular member.

In the racket frame, the release layer may include an inner layer and an outer layer laminated in a thickness direction of the tubular member, and the inner layer and the outer layer may not adhere to each other.

In the racket frame, each of the inner tubular part and the outer tubular part may include a resin layer. The release layer may face each of the resin layers of the inner tubular part and the resin layer of the outer tubular part.

In the racket frame, at least one of the inner tubular part and the outer tubular part may be a fiber-reinforced resin layer. Preferably, the fiber-reinforced resin layer included in the first part, the second part, and the third part may include fibers connected to each other.

In the racket frame, a melting point of a material configuring the release layer may be higher than a molding temperature of the resin layer.

In the racket frame, at least one of the inner tubular part and the outer tubular part may include a metal layer. The release layer may face the metal layer.

A racket according to the present invention includes the racket frame and a string tensioned on a face portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view illustrating a racket frame according to a first embodiment.

FIG. 2 is a sectional view as viewed from an arrow II-II in FIG. 1.

FIG. 3 is a partially enlarged sectional view illustrating a region III in FIG. 2.

FIG. 4 is a sectional view of a face portion of a racket frame according to a second embodiment.

FIG. 5 is a partially enlarged sectional view illustrating a region V in FIG. 4.

FIG. 6 is a view illustrating a method of manufacturing the racket frame of the second embodiment.

FIG. 7 is a sectional view illustrating a modification of the racket frame of the second embodiment.

FIG. 8 is a sectional view illustrating a face portion of a racket frame according to a third embodiment.

FIG. 9 is a partially enlarged sectional view illustrating a region IX in FIG. 8.

FIG. 10 is a view illustrating the method of manufacturing the racket frame of the third embodiment.

FIG. 11 is a sectional view illustrating a face portion of a racket frame according to a fourth embodiment.

FIG. 12 is a plan view illustrating a racket frame according to a fifth embodiment.

FIG. 13 is a sectional view as viewed from an arrow XIII-XIII in FIG. 12.

FIG. 14 is a view illustrating the method of manufacturing the racket frame of the fifth embodiment.

FIG. 15 is a view illustrating a release layer included in a face portion of a racket frame according to a sixth embodiment.

FIG. 16 is a sectional view as viewed from an arrow XVI-XVI in FIG. 15.

FIG. 17 is a sectional view illustrating a face portion of a racket frame according to a seventh embodiment.

FIG. 18 is a sectional view illustrating a face portion of a racket frame according to an eighth embodiment.

FIG. 19 is a plan view illustrating a racket according to a ninth embodiment.

FIG. 20 is a sectional view illustrating a shaft portion of the racket of the ninth embodiment.

FIG. 21 is a view illustrating a method for evaluating compressive strength of the frame in a first example.

FIG. 22 is a view illustrating a method for evaluating compressive stiffness of the frame cross section in the first example.

FIG. 23 is a view illustrating a method of evaluating a lateral spring constant in a third example.

### DESCRIPTION OF THE PREFERRED EMBODIMENTS

With reference to the drawings, embodiments of the present invention will be described below.

### First Embodiment

An embodiment of the present invention will be described below. In the following drawings, the same or corresponding component is designated by the same reference numeral, and the overlapping description will be omitted.

### <Configuration of Racket Frame>

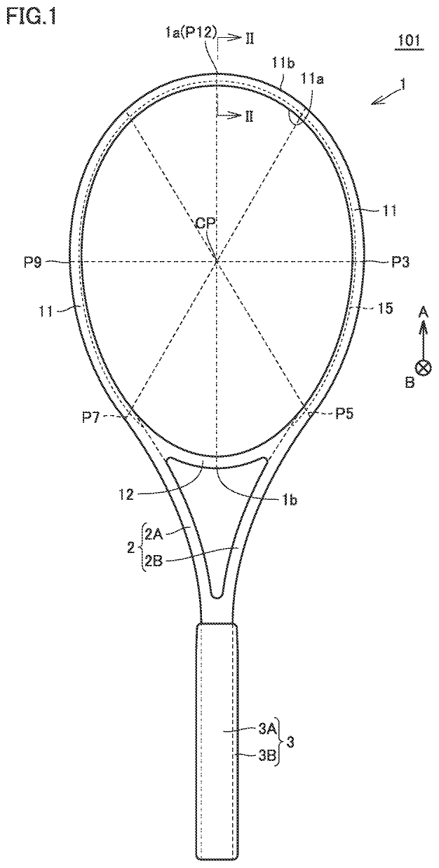

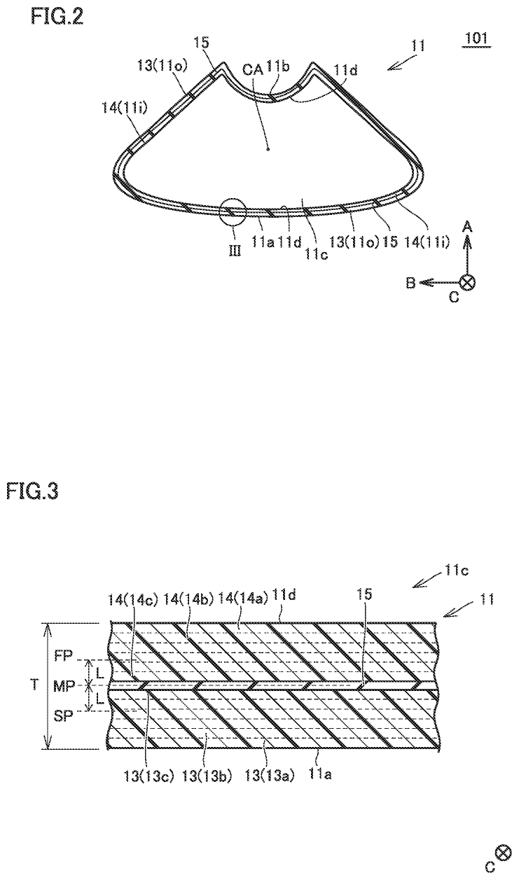

As illustrated in FIG. 1, a racket frame 101 according to the embodiment includes a face portion 1, a shaft portion 2, and a grip portion 3. Face portion 1, shaft portion 2, and grip portion 3 are arranged side by side in a first direction A. In the present specification, a visual field in which racket frame 101 is viewed from a second direction B orthogonal to first direction A is described as planar view. Second direction B is a direction orthogonal to a ball hitting surface formed by stretching a string on face portion 1 of racket frame 101. In addition, in the present specification, a direction orthogonal to each of an extending direction C (see FIG. 2) and second direction B of each part of face portion 1 is referred to as a compressive direction of the part.

Face portion 1 has an elliptical annular shape in planar view. A longitudinal direction of face portion 1 in planar view is along first direction A.

Face portion 1 includes a first end 1a and a second end 1b in first direction A. First end 1a is an end (top end) located on an opposite side of face portion 1 from grip portion 3 in first direction A. Second end 1b is an end (grip end) located on the side of grip portion 3 in first direction A.

Shaft portion 2 includes a first branch member 2A and a second branch member 2B. Grip portion 3 includes a grip member 3A and a grip 3B. First branch member 2A and second branch member 2B branch from grip member 3A. Grip 3B is formed so as to cover grip member 3A. For example, polyurethane is used for grip 3B.

From a different point of view, racket frame 101 includes a first tubular member 11 and a second tubular member 12. In a section orthogonal to extending direction C of first tubular member 11, first tubular member 11 has a tubular shape. A hollow portion 11c (see FIG. 2) is formed inside first tubular member 11. First tubular member 11 includes an inner tubular part 11i facing hollow portion 11c, an outer tubular part 11o surrounding inner tubular part 11i, and a release layer 15 sandwiched between inner tubular part 11i and outer tubular part 11o. In the present specification, release layer 15 means a solid portion or a hollow portion having an arbitrary volume larger than zero and having a non-adhesive surface formed on at least one of between release layer 15 and outer tubular part 11o and between release layer 15 and inner tubular part 11i. In the present specification, the non-adhesive surface means a surface between two layers laminated on each other but not fixed to each other. The non-adhesive surface can be easily observed by sectional observation or the like.

For example, inner tubular part 11i and outer tubular part 11o include a plurality of resin layers. Preferably, at least one of the plurality of resin layers is a fiber-reinforced resin layer. More preferably, each of the plurality of resin layers is a fiber-reinforced resin layer. In a section orthogonal to the extending direction of second tubular member 12, second tubular member 12 has a tubular shape. Second tubular member 12 may have the same configuration as first tubular member 11.

When the position of first end 1a of face portion 1 farthest from grip portion 3 with respect to a center CP of face portion 1 in planar view is a 12 o'clock position P12, a part of face portion 1 located between at least a 7 o'clock position P7 and a 5 o'clock position P5 and including 12 o'clock position P12 is configured of first tubular member 11. The rest of face portion 1 is configured of second tubular member 12.

First tubular member 11 includes a part configuring a part of face portion 1, a part configuring shaft portion 2, and a part configuring grip member 3A. First tubular member 11 has a line-symmetric shape with respect to a central axis passing through first end 1a and extending along first direction A in planar view. Second tubular member 12 is connected to a part configuring a part of face portion 1 in first tubular member 11.

A part configuring a part of face portion 1 of first tubular member 11 includes an inner peripheral surface 11a and an outer peripheral surface 11b. Between inner peripheral surface 11a and outer peripheral surface 11b, a plurality of through-holes (not illustrated) are arranged at intervals in extending direction C of first tubular member 11. The plurality of through-holes are holes through which a string (not illustrated) or a grommet (not illustrated) and the string (not illustrated) pass. As illustrated in FIG. 2, a groove in which a grommet is accommodated is formed on outer peripheral surface 11b of first end 1a of first tubular member 11. The groove extends along extending direction C of first tubular member 11. The groove may be partially or entirely formed on outer peripheral surface 11b of face portion 1. In the part of first tubular member 11 in which the groove is formed, the plurality of through-holes penetrate first tubular member 11 so as to open at each of inner peripheral surface 11a and the bottom surface of the groove.

As illustrated in FIG. 2, for example, outer tubular part 11o of first tubular member 11 is formed of a first group of fiber-reinforced resin layers 13. For example, inner tubular part 11i of first tubular member 11 is formed of a second group of fiber-reinforced resin layers 14. In this case, first tubular member 11 includes the first group of fiber-reinforced resin layers 13, the second group of fiber-reinforced resin layers 14, and release layer 15 sandwiched between the first group of fiber-reinforced resin layers 13 and the second group of fiber-reinforced resin layers 14. At least one of outer tubular part 11o and inner tubular part 11i of first tubular member 11 may further include a metal layer. Outer tubular part 110 of first tubular member 11 may further include a metal layer disposed outside the first group of fiber-reinforced resin layers 13 in the thickness direction of first tubular member 11. Inner tubular part 11i of first tubular member 11 may further include a metal layer disposed inside the second group of fiber-reinforced resin layers 14 in the thickness direction of first tubular member 11 and facing hollow portion 11c. These metal layers may adhere to the first group of fiber-reinforced resin layers 13 or the second group of fiber-reinforced resin layers 14.

In a section orthogonal to extending direction C of first tubular member 11, each of the first group of fiber-reinforced resin layers 13, the second group of fiber-reinforced resin layers 14, and release layer 15 has an annular shape. For example, each of the first group of fiber-reinforced resin layers 13, the second group of fiber-reinforced resin layers 14, and release layer 15 is closed in a circumferential direction with respect to a central axis CA of first tubular member 11.

As illustrated in FIG. 3, each of the first group of fiber-reinforced resin layers 13 and the second group of fiber-reinforced resin layers 14 is configured of a plurality of fiber-reinforced resin layers laminated on each other in a radial direction with respect to central axis CA. In each of the first group of fiber-reinforced resin layers 13 and the second group of fiber-reinforced resin layers 14, two fiber-reinforced resin layers adjacent to each other in the laminating direction are fixed to each other. Each of the plurality of fiber-reinforced resin layers configuring the first group of fiber-reinforced resin layers 13 is in contact with each other without any gap. Each of the plurality of fiber-reinforced resin layers configuring the second-group fiber-reinforced resin layer 14 is in contact with each other without any gap.

For example, the first group of fiber-reinforced resin layers 13 includes a first fiber-reinforced resin layer 13a, a second fiber-reinforced resin layer 13b, and a third fiber-reinforced resin layer 13c. First fiber-reinforced resin layer 13a is disposed on the outermost side with respect to central axis CA in the first group of fiber-reinforced resin layer 13. A part of the outer peripheral surface of first fiber-reinforced resin layer 13a forms inner peripheral surface 11a of first tubular member 11. Second fiber-reinforced resin layer 13b is disposed inside first fiber-reinforced resin layer 13a in the radial direction with respect to central axis CA, and is adjacent to first fiber-reinforced resin layer 13a. Second fiber-reinforced resin layer 13b adheres to first fiber-reinforced resin layer 13a without any gap. Third fiber-reinforced resin layer 13c is disposed on the innermost side with respect to central axis CA in the first group of fiber-reinforced resin layer 13.

For example, the second group of fiber-reinforced resin layers 14 includes a fourth fiber-reinforced resin layer 14a, a fifth fiber-reinforced resin layer 14b, and a sixth fiber-reinforced resin layer 14c. Fourth fiber-reinforced resin layer 14a is disposed on the innermost side with respect to central axis CA in the second group of fiber-reinforced resin layer 14. An inner peripheral surface of fourth fiber-reinforced resin layer 14a faces hollow portion 11c. Fifth fiber-reinforced resin layer 14b is disposed outside fourth fiber-reinforced resin layer 14a in the radial direction with respect to central axis CA, and is adjacent to fourth fiber-reinforced resin layer 14a. Fifth fiber-reinforced resin layer 14b adheres to fourth fiber-reinforced resin layer 14a without any gap. Sixth fiber-reinforced resin layer 14c is disposed outermost with respect to central axis CA in the second group of fiber-reinforced resin layer 14.

Third fiber-reinforced resin layer 13c of the first group of fiber-reinforced resin layers 13 and sixth fiber-reinforced resin layer 14c of the second group of fiber-reinforced resin layers 14 are disposed so as to sandwich release layer 15 in the radial direction with respect to central axis CA (thickness direction of first tubular member 11). Release layer 15 is not fixed to each of third fiber-reinforced resin layer 13c and sixth fiber-reinforced resin layer 14c. From a different point of view, non-adhesive surfaces are formed between release layer 15 and third fiber-reinforced resin layer 13c and between release layer 15 and sixth fiber-reinforced resin layer 14c.

The first group of fiber-reinforced resin layers 13 and the second group of fiber-reinforced resin layers 14 contain a plurality of fibers and a resin impregnated in the plurality of fibers. For example, the plurality of fibers includes at least one selected from the group consisting of carbon fibers, glass fibers, aramid fibers, and Vulcan fibers. For example, the resin includes at least one selected from the group consisting of an epoxy resin, a modified epoxy resin, an unsaturated polyester resin, a polyamide resin, and a phenol resin. The first group of fiber-reinforced resin layers 13 may have the same configuration as or a different configuration from the second group of fiber-reinforced resin layers 14.

For example, an angle formed by the extending direction of each of the plurality of fibers with respect to extending direction C of first tubular member 11 is greater than or equal to 0 degrees and less than 90 degrees. In each of the first group of fiber-reinforced resin layers 13 and the second group of fiber-reinforced resin layers 14, the extending directions of the fibers may intersect each other between two fiber-reinforced resin layers adjacent in the laminating direction. For example, the angle formed by the extending direction of the fiber in one fiber-reinforced resin layer between two fiber-reinforced resin layers adjacent in the laminating direction with respect to the extending direction of first tubular member 11 may be 0 degrees, and the angle formed by the extending direction of the fiber in the other fiber-reinforced resin layer with respect to the extending direction of first tubular member 11 may be 30 degrees. The angle formed by the extending direction of the fibers in the fiber-reinforced resin layers (first fiber-reinforced resin layer 13a and fourth fiber-reinforced resin layer 14a) disposed outermost in the laminating direction among the plurality of fiber-reinforced resin layers with respect to the extending direction of first tubular member 11 may be larger than the angle formed by the extending direction of the fibers in the fiber-reinforced resin layers (second fiber-reinforced resin layer 13b and fifth fiber-reinforced resin layer 14b) adjacent thereto with respect to the extending direction of first tubular member 11. For example, the former angle may be 30 degrees and the latter angle may be 0 degrees.

A melting point of the material configuring release layer 15 is higher than a melting point of the resin material contained in each of the first group of fiber-reinforced resin layers 13 and the second group of fiber-reinforced resin layers 14.

For example, release layer 15 is made of at least one film. In this case, for example, the material configuring release layer 15 includes at least one selected from the group consisting of polypropylene (PP), polyethylene terephthalate (PET), polyvinyl chloride (PVC), polyethylene (PE), polyethylene naphthalate (PEN), polystyrene (PS), acrylic resin (AC), polycarbonate (PC), polyphenylene sulfide (PPS), polytetrafluoroethylene (PTFE), polyether ether ketone resin (PEEK), polyether sulfone (PES), aramid, polyimide (PI), triacetyl cellulose (TAC), and polyvinyl alcohol (PVA). The polypropylene may be biaxially oriented polypropylene (OPP). The polystyrene may be biaxially oriented polystyrene (OPS).

The material configuring release layer 15 may further contain a release agent as a component other than the above-described resin material. For example, the release agent contains at least one selected from the group consisting of an oil/silicon-based release agent, a wax-based release agent, a surfactant, and a fluorine-based release agent.

As illustrated in FIG. 3, for example, in the laminating direction of the plurality of fiber-reinforced resin layers (the thickness direction of first tubular member 11), release layer 15 exists between a first position FP located at a distance L that is 20% of a thickness T in the laminating direction of the plurality of fiber-reinforced resin layers on the side of hollow portion 11c from an intermediate position MP of the plurality of fiber-reinforced resin layers and a second position SP located at a distance L that is 20% of thickness T in the laminating direction of the plurality of fiber-reinforced resin layers on the side opposite to hollow portion 11c from intermediate position MP. Intermediate position MP of the plurality of fiber-reinforced resin layers is an intermediate position between the outer peripheral surface of first fiber-reinforced resin layer 13a and the inner peripheral surface of fourth fiber-reinforced resin layer 14a facing hollow portion 11c. Release layer 15 in FIG. 3 is disposed on intermediate position MP. Release layer 15 may be disposed closer onto the side of hollow portion 11c than first position FP in the radial direction with respect to central axis CA. Furthermore, release layer 15 may be disposed on the side opposite to hollow portion 11c with respect to second position SP in the radial direction with respect to central axis CA.

For example, release layer 15 extends between one end and the other end of first tubular member 11 in extending direction C. In this case, shaft portion 2 and grip portion 3 also include release layer 15. In this case, shaft portion 2 and grip portion 3 tend to bend as compared with the case where shaft portion 2 and grip portion 3 do not include release layer 15.

For example, second tubular member 12 does not include release layer 15. In this case, in face portion 1, only the part configured of first tubular member 11 includes release layer 15. Second tubular member 12 may also include release layer 15. Release layer 15 may be disposed on the entire periphery of face portion 1.

For example, first tubular member 11 can be formed as follows. First, the multilayer body of the plurality of prepreg sheets molded into the plurality of fiber-reinforced resin layers and the film molded into release layer 15 is prepared and wound around a core material. In a state where the multilayer body is wound around the core material, one end in a short direction of the film formed on release layer 15 is connected to the other end in the short direction of the film formed on release layer 15.

Secondly, the multilayer body wound around the core material is heated inside the mold and then taken out. A heating temperature (molding temperature) for the multilayer body is greater than or equal to a curing temperature of the resin material contained in each of the first group of fiber-reinforced resin layers 13 and the second group of fiber-reinforced resin layers 14 and lower than the melting point of the resin material contained in release layer 15. For example, the heating is performed while the multilayer body is pressurized in a multilayer direction.

Thus, in each of the first group of fiber-reinforced resin layers 13 and the second group of fiber-reinforced resin layers 14, two fiber-reinforced resin layers adjacent to each other in the laminating direction are fixed to each other. On the other hand, release layer 15 is not fixed to each of the first group of fiber-reinforced resin layers 13 and the second group of fiber-reinforced resin layers 14.

### <Effect of Racket Frame 101>

In racket frame 101, face portion 1 includes release layer 15 sandwiched between the first group of fiber-reinforced resin layers 13 and the second group of fiber-reinforced resin layers 14.

In each of the first group of fiber-reinforced resin layers 13 and the second group of fiber-reinforced resin layers 14, two fiber-reinforced resin layers adjacent to each other in the laminating direction are fixed to each other. Accordingly, when face portion 1 is deformed during the ball hitting, each of the first group of fiber-reinforced resin layers 13 and the second group of fiber-reinforced resin layers 14 moves integrally. On the other hand, release layer 15 is not fixed to each of the first group of fiber-reinforced resin layers 13 and the second group of fiber-reinforced resin layers 14. Accordingly, when face portion 1 is deformed during hitting a ball, the first group of fiber-reinforced resin layers 13 and the second group of fiber-reinforced resin layers 14 sandwiching the release layer 15 can move independently. As a result, the stiffness of the part of face portion 1 where release layer 15 is disposed is lower than the stiffness of the part of face portion 1 where release layer 15 is not disposed.

On the other hand, the total thickness of the plurality of fiber-reinforced resin layers in the part where release layer 15 is disposed in face portion 1 is greater than the total thickness of the plurality of fiber-reinforced resin layers different from the part only in that release layer 15 is not included. This is because the total thickness is required to be decreased in order to reduce the stiffness without including release layer in the multilayer body of the plurality of fiber-reinforced resin layers. As a result, the strength of the former is higher than the strength of the latter.

That is, in racket frame 101, the stiffness can be reduced while securing the required strength, so that the repulsive performance, the spin performance, and the vibration performance (ball hitting feeling) can be appropriately designed.

In racket frame 101, only first tubular member 11 of first tubular member 11 and second tubular member 12 configuring face portion 1 includes release layer 15. As described above, second tubular member 12 may also include release layer 15, but release layer 15 is required to be appropriately disposed such that the stiffness of face portion 1 does not excessively decrease.

In racket frame 101, a part of face portion 1 that is located between at least 7 o'clock position P7 and 5 o'clock position P5 and includes 12 o'clock position P12 is configured of first tubular member 11 and includes release layer 15. Consequently, in racket frame 101, the stiffness in the compressive direction of each part at 12 o'clock position P12, 3 o'clock position P3, and 9 o'clock position P9 of face portion 1 is lower than that of the racket frame of a comparative example in which release layer 15 is not included and the strength thereof is equivalent to that of racket frame 101.

In racket frame 101, face portion 1 has a tubular shape in the section orthogonal to extending direction C of face portion 1, and release layer 15 is disposed over the entire circumference in the circumferential direction with respect to central axis CA of the tubular shape of face portion 1. In this case, the entire first group of fiber-reinforced resin layers 13 in the circumferential direction can move independently of the entire second group of fiber-reinforced resin layers 14 in the circumferential direction.

### Second Embodiment

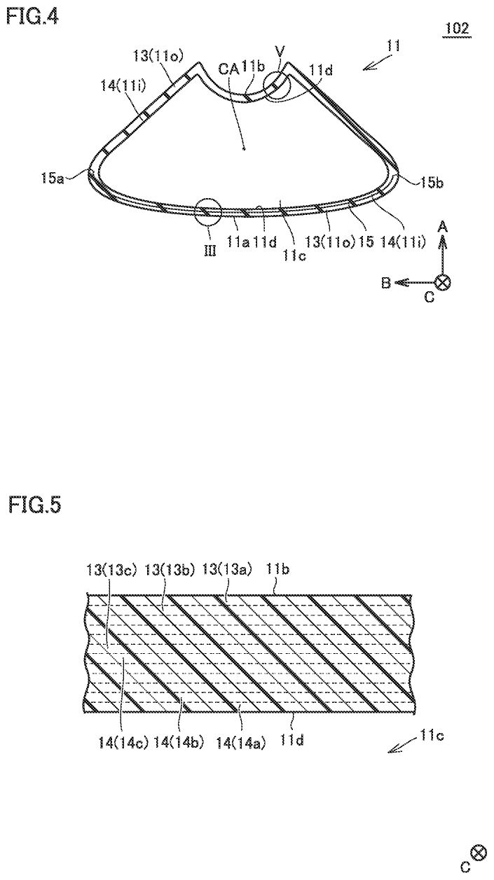

A racket frame 102 according to a second embodiment basically has the same configuration as racket frame 101 of the first embodiment and exhibits the same effect, but is different from racket frame 101 in that release layer 15 is partially disposed in the circumferential direction with respect to central axis CA of face portion 1 as illustrated in FIG. 4. Hereinafter, differences between racket frame 102 and racket frame 101 will be mainly described.

As illustrated in FIG. 4, for example, release layer 15 is disposed only on the inner side (the side of inner peripheral surface 11a) in the compressive direction in the section orthogonal to extending direction C of first tubular member 11. The part of first tubular member 11 in which release layer 15 is disposed has a multilayer structure in FIG. 3.

On the other hand, as illustrated in FIG. 5, in a part of first tubular member 11 where release layer 15 is not disposed, the first group of fiber-reinforced resin layers 13 is fixed to the second group of fiber-reinforced resin layers 14. Third fiber-reinforced resin layer 13c of the first group of fiber-reinforced resin layers 13 adheres to sixth fiber-reinforced resin layer 14c of the second group of fiber-reinforced resin layers 14 without any gap.

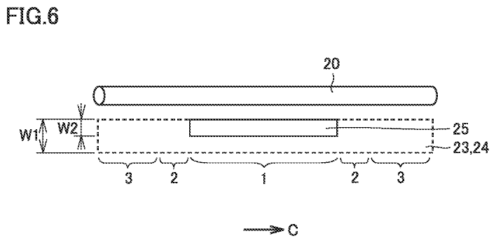

First tubular member 11 of the second embodiment can be formed basically similarly to first tubular member 11 of the first embodiment. As illustrated in FIG. 6, in the second embodiment, a film 25 in which a length W2 in the short direction is shorter than a length W1 in the short direction of the plurality of prepreg sheets 23, 24 molded in the plurality of fiber-reinforced resin layers is used as the film molded in release layer 15. Length W2 of film 25 in the short direction is shorter than the length of a core material 20 in the circumferential direction. In FIG. 6, the prepreg sheet is indicated by a broken line for convenience of description.

### <Modifications>

In racket frame 102, for example, release layer 15 may be disposed only on outer peripheral surface 11b in the section orthogonal to the extending direction of face portion 1.

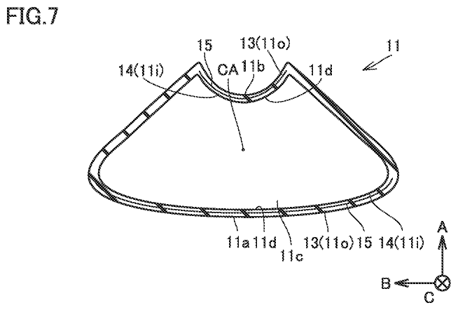

Face portion 1 of racket frame 102 may include a plurality of release layers 15 spaced apart from each other in the circumferential direction with respect to central axis CA of face portion 1. For example, as illustrated in FIG. 7, release layer 15 is disposed only on the inner side (the side of inner peripheral surface 11a) and the outer side (the side of outer peripheral surface 11b) in the compressive direction in the section orthogonal to extending direction C of first tubular member 11. For example, each of the plurality of release layers 15 exists between first position FP and second position SP in the multilayer direction. The positions of the plurality of release layers 15 in the multilayer direction may be the same as or different from each other. Each of the plurality of release layers 15 may be sandwiched between two common fiber-reinforced resin layers, or sandwiched between two different fiber-reinforced resin layers.

### Third Embodiment

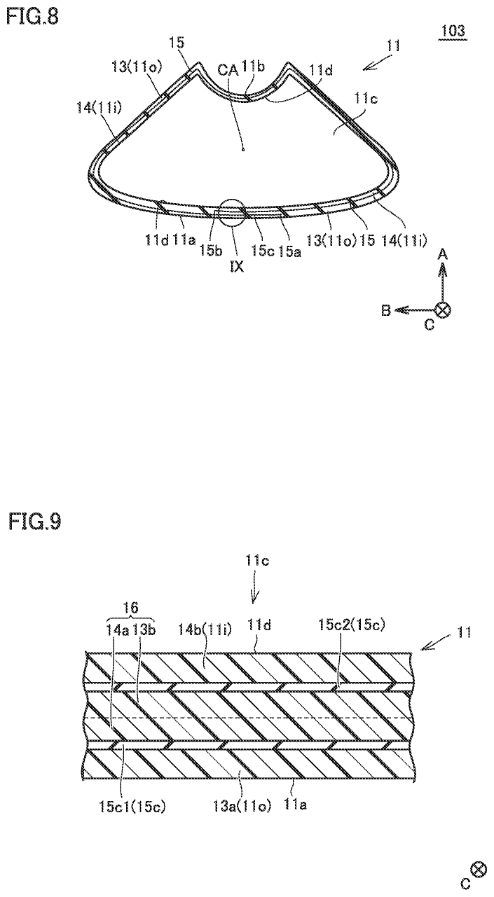

A racket frame 103 according to a third embodiment basically has the same configuration as racket frame 101 of the first embodiment and exhibits the same effect as racket frame 101 of the first embodiment. However, as illustrated in FIG. 8, racket frame 103 is different from racket frame 101 in that release layer 15 has an overlapping region 15c disposed so as to be spaced apart and overlap partially in the radial direction with respect to central axis CA of face portion 1. Differences between racket frame 103 and racket frame 101 will be mainly described below.

As illustrated in FIG. 8, release layer 15 has one end 15a and the other end 15b in the circumferential direction with respect to central axis CA. One end 15a is not in contact with the other end 15b. One end 15a is disposed outside the other end 15b in the radial direction with respect to central axis CA. One end 15a is disposed at an interval from the other end 15b in the circumferential direction with respect to central axis CA. A part of release layer 15 continuous with the other end 15b in the circumferential direction is disposed so as to overlap with a part of release layer 15 continuous with the one end 15a in the circumferential direction at an interval in the radial direction. A part (hereinafter, also referred to as a first overlapping part 15c1) of release layer 15 continuous with the one end 15a and a part (hereinafter, also referred to as a second overlapping part 15c2) of release layer 15 continuous with the other end 15b form overlapping region 15c. For example, the position of overlapping region 15c in the circumferential direction is disposed on the side of inner peripheral surface 11a with respect to central axis CA. For example, the position of overlapping region 15c in the circumferential direction may be disposed on the side of outer peripheral surface 11b with respect to central axis CA.

As illustrated in FIG. 9, first overlapping part 15c1 is sandwiched between first fiber-reinforced resin layer 13a and fourth fiber-reinforced resin layer 14a as outer tubular part l lo. Second overlapping part 15c2 is sandwiched between second fiber-reinforced resin layer 13b and fifth fiber-reinforced resin layer 14b as inner tubular part 11i. A third group of fiber-reinforced resin layers 16 is disposed between first overlapping part 15c1 and second overlapping part 15c2. In the third group of fiber-reinforced resin layers 16, fourth fiber-reinforced resin layer 14a adjacent to first overlapping part 15c1 in the laminating direction and second fiber-reinforced resin layer 13b adjacent to second overlapping part 15c2 in the laminating direction are laminated and fixed without any gap.

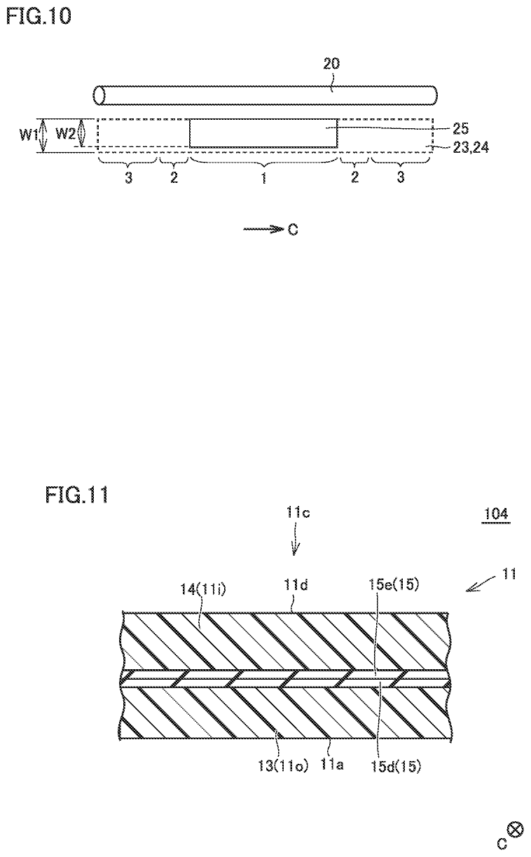

First tubular member 11 of the third embodiment can be formed basically similarly to first tubular member 11 of the first embodiment. As illustrated in FIG. 10, in the third embodiment, film 25 in which length W2 in the short direction is longer than the circumferential length of core material 20 is used as the film molded in release layer 15.

In racket frame 103, when face portion 1 is deformed during the ball hitting, the first group of fiber-reinforced resin layers 13 and the third group of fiber-reinforced resin layers 16 sandwiching the first overlapping part 15c1 of release layer 15 can move independently of each other, and the third group of fiber-reinforced resin layers 16 and the second group of fiber-reinforced resin layers 14 sandwiching second overlapping part 15c2 of release layer 15 can move independently of each other. As a result, in racket frame 103, the stiffness of the part of face portion 1 where overlapping region 15c of release layer 15 is disposed is further lower than the stiffness of the part of face portion 1 where release layer 15 is disposed but the overlapping region 15c is not disposed.

### <Modifications>

Racket frame 103 may have the same configuration as racket frame 102 except that release layer 15 has overlapping region 15c. In other words, in racket frame 103, release layer 15 may be partially disposed in the circumferential direction with respect to central axis CA of face portion 1. For example, release layer 15 may be disposed only on the side of inner peripheral surface 11 a with respect to central axis CA, and have overlapping region 15c on the side of inner peripheral surface 11a with respect to central axis CA.

### Fourth Embodiment

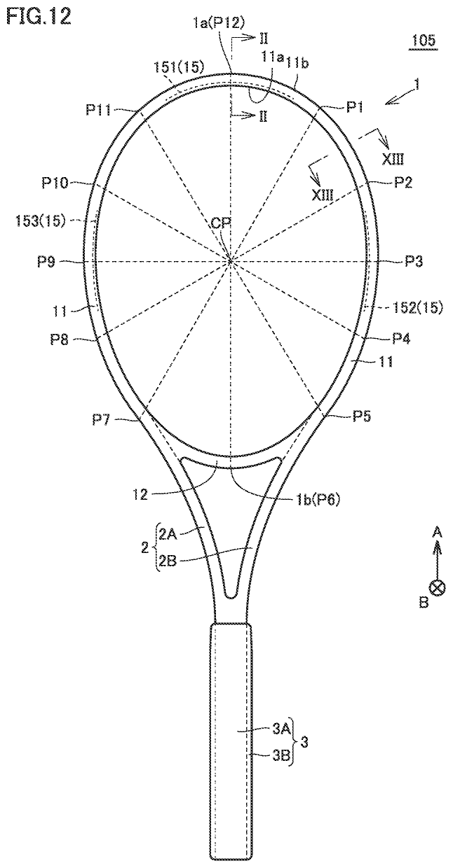

A racket frame 104 according to a fourth embodiment basically has the same configuration as the racket frame 101 of the first embodiment and exhibits the same effect as that of racket frame 101, but is different from racket frame 101 in that release layer 15 includes a first layer 15d (outer layer) and a second layer 15e (inner layer) laminated in the thickness direction of first tubular member 11 as illustrated in FIG. 11, and that the non-adhesive surface is formed between first layer 15d and second layer 15e. Differences between racket frame 104 and racket frame 101 will be mainly described below.

First layer 15d is disposed between the first-group of fiber-reinforced resin layer 13 and second layer 15e. Second layer 15e is disposed between first layer 15d and the second-group of fiber-reinforced resin layer 14. The non-adhesive surfaces are formed between first layer 15d and the first group of fiber-reinforced resin layers 13 and between second layer 15e and the second group of fiber-reinforced resin layers 14. The non-adhesive surface is also formed between first layer 15d and second layer 15e.

In other words, first layer 15d is not fixed to both the first-group of fiber-reinforced resin layer 13 and second layer 15e. Second layer 15e is not fixed to the second-group of fiber-reinforced resin layer 14 and first layer 15d.

First tubular member 11 of the fourth embodiment can be formed basically similarly to first tubular member 11 of the first embodiment.

In racket frame 104, when face portion 1 is deformed during the ball hitting, the first group of fiber-reinforced resin layers 13 can move independently with respect to first layer 15d, the second group of fiber-reinforced resin layers 14 can move independently with respect to second layer 15e, and first layer 15d and second layer can move independently of each other.

### <Modifications>

Racket frame 104 may have the same configuration as racket frame 102 or racket frame 103 except that release layer 15 includes first layer 15d and second layer In other words, in racket frame 104, first layer 15d and second layer 15e of release layer 15 may be partially disposed in the circumferential direction with respect to central axis CA of face portion 1. In racket frame 104, release layer 15 may have overlapping region 15c.

### Fifth Embodiment

A racket frame 105 according to a fifth embodiment basically has the same configuration as the racket frame 101 of the first embodiment and exhibits the same effect as that of racket frame 101, but is different from racket frame 101 in that a part (third part) of face portion 1 at 2 o'clock position P2 in planar view as illustrated in FIG. 12 does not include release layer 15. Differences between racket frame 105 and racket frame 101 will be mainly described below.

As illustrated in FIG. 12, in racket frame 105, a part (first part) including first end 1a at 12 o'clock position P12, a part (second part) at 3 o'clock position P3, and a part at 9 o'clock position P9 of face portion 1 include release layer 15.

For example, release layer 15 includes a first release layer 151, a second release layer 152, and a third release layer 153 that are disposed at intervals in the extending direction of first tubular member 11. First release layer 151 passes through 12 o'clock position P12 and is disposed between 11 o'clock position P11 and 1 o'clock position P1. Second release layer 152 passes through 3 o'clock position P3 and is disposed between 2 o'clock position P2 and 4 o'clock position P4. Third release layer 153 passes through 9 o'clock position P9 and is disposed between 8 o'clock position P8 and 10 o'clock position P10.

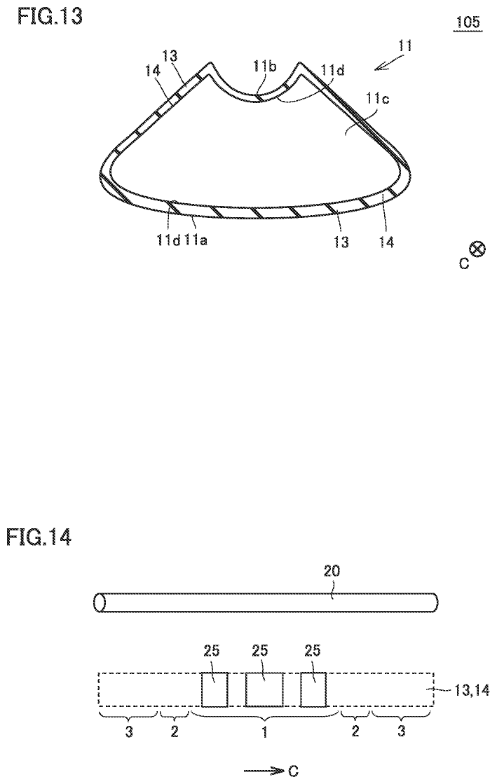

As illustrated in FIGS. 12 and 13, the part (third part) of face portion 1 at 2 o'clock position P2 and the part at 10 o'clock position P10 do not include release layer For example, in face portion 1, a part between 1 o'clock position P1 and 2o ′clock position P2, a part between 4 o'clock position P4 and 5 o'clock position P5, a part between 7 o'clock position P7 and 8 o'clock position P8, and a part between 10 o'clock position P10 and 11 o'clock position P11 do not include release layer 15.

The sectional structure orthogonal to extending direction C of first tubular member 11 of racket frame 105 is equivalent at each position of face portion 1 except for the presence or absence of release layer 15. In first tubular member 11, the number of multilayers of the plurality of fiber-reinforced resin layers is equal at each position of face portion 1. The plurality of fiber-reinforced resin layers included in the part (first part) at 12 o'clock position, the part (second part) at 3 o'clock position P3, and the part (third part) at 2 o'clock position P2 in face portion 1 include fibers connected in the first part, the second part, and the third part. Preferably, first tubular member 11 includes fibers continuous from one end to the other end thereof. The plurality of fiber-reinforced resin layers included in the first part, the second part, and the third part of face portion 1 may further include fibers that are not continuous in each part. For example, first tubular member 11 may include fibers connected to the first part, the second part, and the third part, and fibers disposed only in the first part.

First tubular member 11 of the fifth embodiment can be formed basically similarly to first tubular member 11 of the first embodiment. As illustrated in FIG. 14, in the fifth embodiment, as the film molded in release layer 15, a plurality of films 25 having the length in one direction (for example, the longitudinal direction) shorter than the length in the extending direction of the part of first tubular member 11 molded in face portion 1 is used. The plurality of films 25 are arranged at intervals in extending direction C of first tubular member 11, and are wound around core material 20 together with the plurality of prepreg sheets 23, 24.

In racket frame 105, the part (third part) of face portion 1 at 2 o'clock position P2 in planar view does not include release layer 15. From the viewpoint of improving the repulsive performance of racket frame 105, preferably the stiffness in the compressive direction of each part of face portion 1 at the 12 o'clock position, 3 o'clock position, and 9 o'clock position is low. In this way, because racket frame 105 is easily elastically deformed in first direction A and the direction (lateral direction) orthogonal to first direction A and second direction B, the repulsive performance during the ball hitting is enhanced. On the other hand, the stiffness in the compressive direction of the part of face portion 1 at 2 o'clock position P2 does not contribute to improvement of the repulsive performance of racket frame 105 as much as the stiffness in the compressive direction of the parts of face portion 1 at the 12 o'clock position, 3 o'clock position, and 9 o'clock position. On the other hand, in racket frame 105, because the part of face portion 1 at 2 o'clock position P2 does not include release layer 15, the stiffness of the part is higher than that of racket frame 101, and as a result, the strength is higher.

That is, in racket frame 105, the strength can be higher than that of racket frame 101 while the repulsive performance equivalent to that of racket frame 101 is implemented.

In addition, a technique of changing the laminated structure of the fiber-reinforced resin layers in each part in the extending direction of the first tubular member to form a thick portion in which a large number of fiber-reinforced resin layers are laminated and a thin portion in which a small number of fiber-reinforced resin layers are laminated is conceivable as a technique of implementing a relatively high stiffness part and a relatively low stiffness part in extending direction C of first tubular member 11 without including release layer 15. However, in this technique, the first tubular member does not include continuous fibers in each of the first part, the second part, and the third part (from a different point of view, fibers continuous from one end to the other end of the first tubular member are not included), and unintended changes in stiffness and strength may be generated. On the other hand, in racket frame 105, because first tubular member 11 includes continuous fibers in each of the first part, the second part, and the third part, unintended changes in stiffness and strength are hardly generated. In racket frame 105, when first tubular member 11 includes fibers continuous from one end to the other end thereof, unintended changes in stiffness and strength are further hardly generated.

### <Modifications>

Racket frame 105 may have the same configuration as racket frame 102, racket frame 103, or racket frame 104 except that the part (third part) of face portion 1 at 2 o'clock position P2 does not include release layer 15.

### Sixth Embodiment

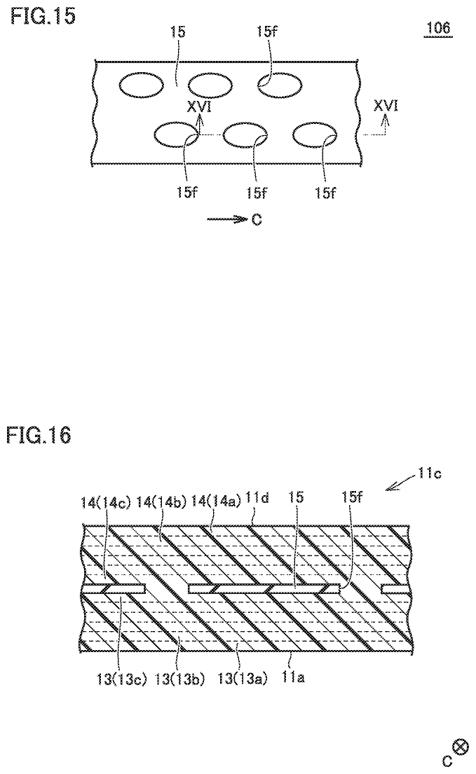

A racket frame 106 according to a sixth embodiment basically has the same configuration as that of racket frame 101 of the first embodiment and exhibits the same effect as that of racket frame 101, but is different from racket frame 101 in that a through-hole 15f penetrating release layer 15 in the laminating direction of the plurality of fiber-reinforced resin layers is made in release layer 15 as illustrated in FIGS. 15 and 16. Differences between racket frame 106 and racket frame 101 will be mainly described below.

In release layer 15, for example, a plurality of through-holes 15f are made. The plurality of through-holes 15f are arranged at intervals in extending direction C of first tubular member 11. At least one through-hole 15f may be made in release layer Through-hole 15f is filled with resin. Third fiber-reinforced resin layer 13c is fixed to sixth fiber-reinforced resin layer 14c inside through-hole 15f.

First tubular member 11 of the sixth embodiment can be formed basically similarly to first tubular member 11 of the first embodiment. In the sixth embodiment, the film having the through-hole is used as the film molded in release layer 15. When the multilayer body of the film and the plurality of prepreg sheets is pressurized and heated, the resins contained in the two prepreg sheets sandwiching the film flow into the through-holes and adhere to each other without any gap.

In first tubular member 11 of racket frame 106, the stiffness of the part where through-hole 15f is made in release layer 15 is higher than the stiffness of the part where through-hole 15f is not made in release layer 15. This is because third fiber-reinforced resin layer 13c adheres to sixth fiber-reinforced resin layer 14c without any gap in through-hole 15f. Accordingly, in racket frame 106, a part having higher stiffness than racket frame 101 can be designed.

The adhesive part between third fiber-reinforced resin layer 13c and sixth fiber-reinforced resin layer 14c formed in through-hole 15f is more easily peeled off than a part where third fiber-reinforced resin layer 13c and sixth fiber-reinforced resin layer 14c adhere directly to each other without including release layer 15. For example, the adhesive part between third fiber-reinforced resin layer 13c and sixth fiber-reinforced resin layer 14c formed in through-hole 15f is gradually peeled off by being repeatedly balled. As a result, in racket frame 106, the stiffness of the adhesive part can be gradually reduced.

### <Modifications>

Racket frame 106 may have the same configuration as racket frame 102, racket frame 103, racket frame 104, or racket frame 105 except that the through-hole 15f is made in release layer 15.

In racket frame 106, a sum of the opening areas of through-holes 15f may be different depending on the position of first tubular member 11 in extending direction C. For example, the sum of the opening areas of through-holes 15f made in release layer included in the part of face portion 1 at 2 o'clock position P2 in planar view may be larger than the sum of the opening areas of through-holes 15f made in release layer 15 included in each part of face portion 1 at 12 o'clock position P12 and 3 o'clock position P3.

### Seventh Embodiment

A racket frame 107 according to a seventh embodiment has a configuration basically similar to that of racket frame 101 of the first embodiment and exhibits a similar effect, but is different from racket frame 101 in that one of outer tubular part 11o and inner tubular part 11i of first tubular member 11 includes the metal layer, and release layer 15 faces the metal layer. Differences between racket frame 107 and racket frame 101 will be mainly described below.

In racket frame 107 illustrated in FIG. 17, outer tubular part 110 of first tubular member 11 is configured of a first metal layer 17. First metal layer 17 is disposed outside release layer 15 in the thickness direction of first tubular member 11. The non-adhesive surface is formed between first metal layer 17 and release layer 15 and between the second group of fiber-reinforced resin layers 14 and sixth fiber-reinforced resin layer 14c.

The material configuring first metal layer 17 may be any metal material, and for example, includes aluminum (Al).

In racket frame 107, inner tubular part 11i of first tubular member 11 may be formed of the metal layer. Racket frame 107 may have the same configuration as any of racket frames 102 to 106 except that one of outer tubular part 11o and inner tubular part 11i of first tubular member 11 includes the metal layer, and that the non-adhesive surface is formed at least one of between the metal layer and the release layer and between the resin layer and the release layer.

In racket frame 107, outer tubular part 11o of first tubular member 11 may further include the resin layer disposed outside first metal layer 17 in the thickness direction of first tubular member 11. Inner tubular part 11i of first tubular member 11 may further include a second metal layer disposed inside a second group of fiber-reinforced resin layers 14 in the thickness direction of first tubular member 11.

### Eighth Embodiment

A racket frame 108 according to an eighth embodiment has a configuration basically similar to that of racket frame 101 of the first embodiment and exhibits a similar effect, but is different from racket frame 101 in that each of outer tubular part 11o and inner tubular part 11i of first tubular member 11 includes the metal layer, and that release layer 15 faces the metal layer of each of outer tubular part 11o and inner tubular part 11i. Differences between the racket frame 108 and the racket frame 101 will be mainly described below.

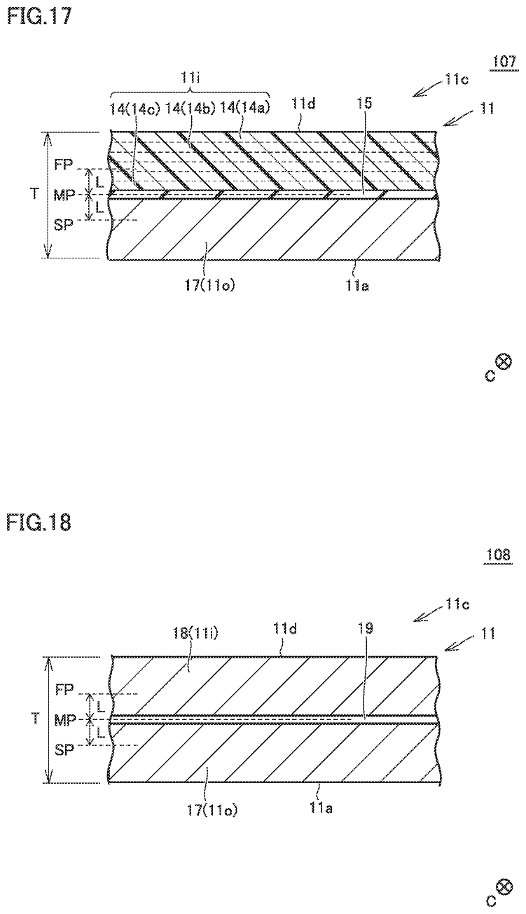

In racket frame 108 of FIG. 18, outer tubular part 11o of first tubular member 11 is formed of first metal layer 17, and inner tubular part 11i is formed of second metal layer 18. First tubular member 11 includes first metal layer 17, second metal layer 18, and a release layer 19 sandwiched between first metal layer 17 and second metal layer 18. The non-adhesive surface is formed between first metal layer 17 and release layer 19 and between second metal layer 18 and release layer 19.

For example, release layer 19 is a hollow layer. In this case, release layer 19 is made of a gas such as air. A part of the release layer 19 may be the hollow layer, and the rest may be a solid layer. Entire release layer 19 may be the solid layer. The material configuring release layer 19 may be any material that does not adhere to each of first metal layer 17 and second metal layer 18, and may be the same as the material configuring release layer 15.

Racket frame 108 may have a configuration similar to any of racket frames 102 to 106 except that each of outer tubular part 11o and inner tubular part 11i of first tubular member 11 includes the metal layer.

In racket frame 108, outer tubular part 11o of first tubular member 11 may further include the resin layer surrounding first metal layer 17. Inner tubular part 11i of first tubular member 11 may further include the resin layer that is surrounded by second metal layer 18 and faces hollow portion 11c.

### Ninth Embodiment

Each of racket frames 101 to 108 of the first to eighth embodiment becomes a racket by stretching a string 4 on each face portion 1.

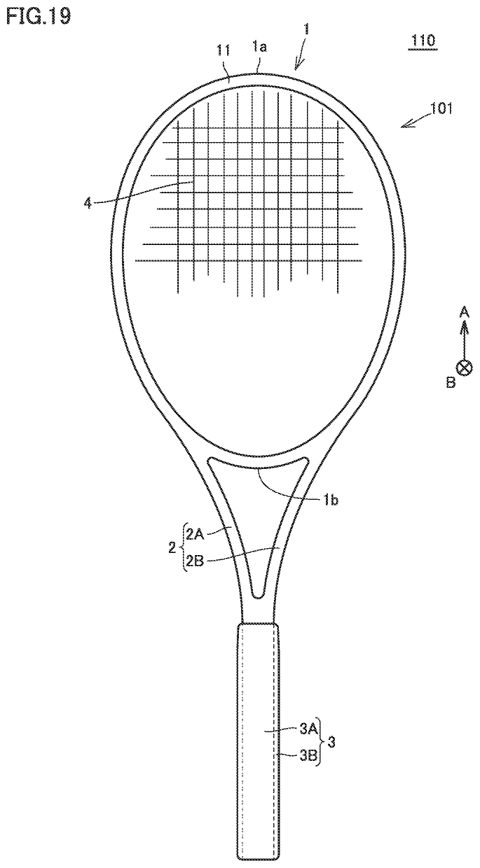

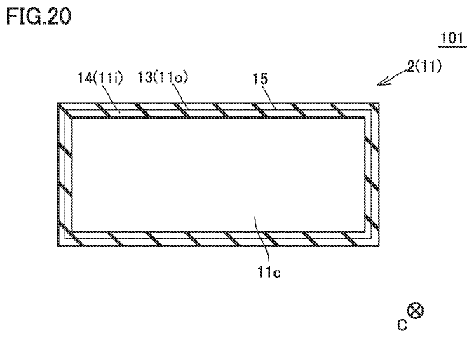

As illustrated in FIG. 19, a racket 110 includes racket frame 101 and string 4 pitched on face portion 1 of racket frame 101. Racket 110 may include racket frame 102, racket frame 103, racket frame 104, racket frame 105, racket frame 106, racket frame 107, or racket frame 108 instead of racket frame 101. As described above, when racket 110 includes racket frame 101, first tubular member 11 configuring shaft portion 2 also includes release layer 15 as illustrated in FIG. 20.

Because racket 110 includes any one of racket frames 101 to 108, the above effect of racket frame 101 to 108 is obtained.

### First example

The present inventors evaluated the relationship between the compressive stiffness and the compressive strength of a racket frame according to samples 1 to 4 described below.

Sample 1 was racket frame 101. Samples 2 to 4 contained no release layer, and the total thickness of the plurality of fiber-reinforced resin layers and a fiber orientation angle were adjusted in order to lower the compressive stiffness.

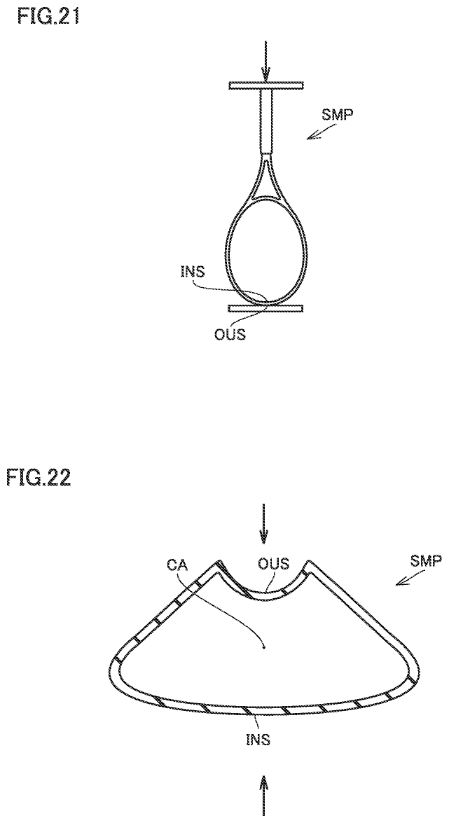

As illustrated in FIG. 21, a load was applied in a direction toward the face portion side with respect to the grip portion (the direction of an arrow in FIG. 21) in a state where each of the racket frames of examples 1 to 4 was disposed such that the first direction was the vertical direction, and the compressive strength of each sample was evaluated based on the generated displacement. Furthermore, the load was applied to each of an outer peripheral surface OUS and an inner peripheral surface INS of a part of the face portion at the 12 o'clock position of each of racket frames of samples 1 to 4 in the direction (the direction of an arrow in FIG. 22) toward the central axis of the tubular member, and the compressive stiffness of each sample was evaluated based on the generated displacement. The results are illustrated in Table 1.

TABLE 1

| | Compressive stiffness | Compression strength |
|---|---|---|
| | (kgf/mm) | (kgf) |
| Sample 1 | 13.2 | 71.0 |
| Sample 2 | 22.7 | 46.0 |
| Sample 3 | 28.7 | 49.7 |
| Sample 4 | 38.7 | 105.5 |

As illustrated in Table 1, in samples 2 to 4 containing no release layer, it was confirmed that the higher the strength, the higher the compressive stiffness. On the other hand, the compressive stiffness of sample 1 was lower than that of each of samples 2 to 4, but the strength of sample 1 was higher than that of each of samples 2, 3. From this example, it has been confirmed that racket frames 101 to 106 can achieve high repulsive performance with low compressive stiffness while securing the strength.

### Second Example

The present inventors evaluated the relationship between the compressive stiffness and bending fracture strength using the tubular member extending linearly before being bent into the racket frame as a test piece. A test piece 1 was a tubular member equivalent to first tubular member 11 of the racket frame of sample 1. A test piece 2 was a tubular member equivalent to the tubular member of the racket frame of sample 2.

A test piece 3 was first tubular member 11 of racket frame 102. A test piece 4 corresponded to a modification of racket frame 102, and was first tubular member 11 in which release layer 15 was disposed only on the side of outer peripheral surface 11b in the section orthogonal to extending direction C of first tubular member 11.

A test piece 5 corresponded to a modification of racket frame 101, and was first tubular member 11 in which release layer 15 was disposed on the side of hollow portion 11c (inside) with respect to first position FP in the radial direction with respect to central axis CA. A test piece 6 corresponded to a modification of racket frame 101, and was first tubular member 11 in which release layer 15 is disposed on the side (outer side) opposite to hollow portion 11c with respect to first position FP in the radial direction with respect central axis CA.

The compressive stiffness of each of the tubular members of test pieces 1 to 6 was evaluated in the same manner as in the first example. Furthermore, a three-point bending test was performed on each of the tubular members of test pieces 1 to 6. In the three-point bending test, in the state in which outer peripheral surface OUS and inner peripheral surface INS of each tubular member were opposed to each other in the vertical direction and two points of each tubular member were supported on a horizontal plane, the load was applied from the upper side to the lower side to a part located at the center between the two points, and three-point bending fracture strength was evaluated based on the maximum load at which each tubular member reached bending fracture.

As a result of the evaluation, the three-point bending fracture strength of each of test pieces 1 and 3 to 6 was equivalent to that of test piece 2. On the other hand, the compressive stiffness of each of test pieces 1 and 3 to 6 was sufficiently lower than the compressive stiffness of test piece 2, and was less than 70% of the compressive stiffness of test piece 2. In addition, the compressive stiffness of test piece 5 was lower than the compressive stiffness of test piece 6. The reason for this is presumed as follows. First, as release layer 15 is disposed on the inside in the radial direction with respect to central axis CA of first tubular member 11, a maximum diameter of the plurality of fiber-reinforced resin layers located on the inside of release layer 15 in the radial direction becomes smaller, and the plurality of fiber-reinforced resin layers located on the inside of release layer 15 in the radial direction become softer. Then, as release layer 15 is disposed on the inside in the radial direction with respect to central axis CA of first tubular member 11, hard parts of the plurality of fiber-reinforced resin layers easily move independently of other parts, and as a result, the compressive stiffness decreases.

### Third Example

The present inventors evaluated the compressive stiffness and a spring constant of the racket frames of samples 1, 5. Sample 5 was racket frame 105.

The compressive stiffness of a part of the face portion at the 12 o'clock position of each of samples 1, 5 was evaluated by the same method as the method for evaluating the compressive stiffness in the first example. In addition, the compressive stiffness of each part of face portion 1 at the 2 o'clock position, the 3 o'clock position, and the 4 o'clock position of each of samples 1, 5 was evaluated based on the displacement generated when the load was applied to each of inner peripheral surface 11a and outer peripheral surface 11b of each part in the direction toward central axis CA of first tubular member 11.

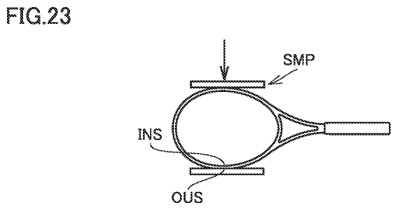

Furthermore, longitudinal spring constants of samples 1, 5 were evaluated by the same method as the method for evaluating the compressive strength in the first example. In addition, transverse spring constants of the racket frames of samples 1, 5 were evaluated. Specifically, as illustrated in FIG. 23, the load was applied to a part of face portion 1 at the 3 o'clock position in the direction toward a part at the 9 o'clock position in the state where the racket frames of samples 1, 5 were arranged such that the ball hitting surface was along the vertical direction and such that the first direction was in the horizontal direction, and the transverse spring constant of each sample was evaluated based on the displacement generated in each part.

As a result of the evaluation, it was confirmed that the vertical spring constant and the horizontal spring constant of each of samples 1, 5 were equivalent, but on the other hand, the compressive stiffness of the part of sample 5 at 2 o'clock position P2 of face portion 1 was higher than the compressive stiffness of the part of sample 1 at 2 o'clock position P2 of face portion 1. That is, it was confirmed that sample 5 had higher strength than sample 1.

[Supplementary note 1] A racket frame including: a face portion having an annular shape in planar view, a grip portion, and a shaft portion connecting the face portion and the grip portion, in which at least a part of the face portion, the grip portion, and the shaft portion includes a tubular member, and in a section orthogonal to an extending direction of the tubular member, the tubular member includes an inner tubular part, an outer tubular part surrounding the inner tubular part, and a release layer sandwiched between the inner tubular part and the outer tubular part.
[Supplementary note 2] The racket frame described in supplementary note 1, in which only a part of the face portion includes the release layer in an extending direction of the face portion.
[Supplementary note 3] The racket frame described in supplementary note 2, in which when a position of a first part of the face portion farthest from the grip portion in planar view is a 12 o'clock position, the first part of the face portion and a second part at a 3 o'clock position include the release layer, and a third part of the face portion at a 2 o'clock position does not include the release layer.
[Supplementary note 4] The racket frame described in any one of supplementary notes 1 to 3, in which the entire face portion in the extending direction includes the release layer.
[Supplementary note 5] The racket frame described in any one of supplementary note 1 to 4, in which the release layer is partially disposed in a circumferential direction of the tubular member in a section orthogonal to an extending direction of the face portion.
[Supplementary note 6] The racket frame described in any one of supplementary notes 1 to 4, in which the release layer is disposed over an entire circumference in a circumferential direction of the tubular member in a section orthogonal to an extending direction of the face portion.
[Supplementary note 7] The racket frame described in any one of supplementary notes 1 to 6, in which the release layer exists between a first position at a distance of 20% of a thickness of the tubular member inside from an intermediate position of the tubular member and a second position at a distance of the 20% outside from the intermediate position in a thickness direction of the tubular member.
[Supplementary note 8] The racket frame described in any one of supplementary notes 1 to 7, in which a through-hole penetrating the release layer is made in the release layer in a thickness direction of the tubular member.
[Supplementary note 9] The racket frame described in any one of supplementary notes 1 to 8, in which the release layer includes an inner layer and an outer layer laminated in a thickness direction of the tubular member, and the inner layer and the outer layer do not adhere to each other.
[Supplementary note 10] The racket frame described in any one of supplementary notes 1 to 9, in which each of the inner tubular part and the outer tubular part includes a resin layer, and the release layer faces each of the resin layers of the inner tubular part and the resin layer of the outer tubular part.
[Supplementary note 11] The racket frame described in supplementary note 3, in which at least one of the inner tubular part and the outer tubular part is a fiber-reinforced resin layer, and the fiber-reinforced resin layer included in the first part, the second part, and the third part includes fibers connected to each other.
[Supplementary note 12] The racket frame described in supplementary note 10 or 11, in which a melting point of a material configuring the release layer is higher than a molding temperature of the resin layer.
[Supplementary note 13] The racket frame described in any one of supplementary notes 1 to 12, in which at least one of the inner tubular part and the outer tubular part includes a metal layer, and the release layer faces the metal layer.
[Supplementary note 14] A racket including: the racket frame described in any one of supplementary notes 1 to 13; and a string tensioned on the face portion.

Although the embodiments of the present invention have been described, it should be considered that the disclosed embodiment is an example in all respects and not restrictive. The scope of the present invention is indicated by the claims, and it is intended that all modifications within the meaning and scope of the claims are included in the present invention.

What is claimed is:

1. A racket frame comprising:
a face portion having an annular shape in planar view, a grip portion, and a shaft portion connecting the face portion and the grip portion,
wherein at least a part of the face portion, the grip portion, and the shaft portion includes a tubular member, and
in a section orthogonal to an extending direction of the tubular member, the tubular member includes an inner tubular part, an outer tubular part surrounding the inner tubular part, and a release layer sandwiched between the inner tubular part and the outer tubular part.

2. The racket frame according to claim 1, wherein only a part of the face portion includes the release layer in an extending direction of the face portion.

3. The racket frame according to claim 2, wherein when a position of a first part of the face portion farthest from the grip portion in planar view is a 12 o'clock position, the first part of the face portion and a second part at a 3 o'clock position include the release layer, and a third part of the face portion at a 2 o'clock position does not include the release layer.

4. The racket frame according to claim 1, wherein the entire face portion in the extending direction includes the release layer.

5. The racket frame according to claim 1, wherein the release layer is partially disposed in a circumferential direction of the tubular member in a section orthogonal to an extending direction of the face portion.

6. The racket frame according to claim 1, wherein the release layer is disposed over an entire circumference in a circumferential direction of the tubular member in a section orthogonal to an extending direction of the face portion.

7. The racket frame according to claim 1, wherein the release layer exists between a first position at a distance of 20% of a thickness of the tubular member inside from an intermediate position of the tubular member and a second position at a distance of the 20% outside from the intermediate position in a thickness direction of the tubular member.

8. The racket frame according to claim 1, wherein a through-hole penetrating the release layer is made in the release layer in a thickness direction of the tubular member.

9. The racket frame according to claim 1, wherein the release layer includes an inner layer and an outer layer laminated in a thickness direction of the tubular member, and
the inner layer and the outer layer do not adhere to each other.

10. The racket frame according to claim 1, wherein each of the inner tubular part and the outer tubular part includes a resin layer, and
the release layer faces each of the resin layers of the inner tubular part and the resin layer of the outer tubular part.

11. The racket frame according to claim 3, wherein at least one of the inner tubular part and the outer tubular part is a fiber-reinforced resin layer, and
the fiber-reinforced resin layer included in the first part, the second part, and the third part includes fibers connected to each other.

12. The racket frame according to claim 10, wherein a melting point of a material configuring the release layer is higher than a molding temperature of the resin layer.

13. The racket frame according to claim 1, wherein at least one of the inner tubular part and the outer tubular part includes a metal layer, and
the release layer faces the metal layer.

14. A racket comprising:
the racket frame according to claim 1; and
a string tensioned on the face portion.

15. The racket frame according to claim 2, wherein each of the inner tubular part and the outer tubular part includes a resin layer, and
the release layer faces each of the resin layer of the inner tubular part and the resin layer of the outer tubular part.

16. The racket frame according to claim 3, wherein each of the inner tubular part and the outer tubular part includes a resin layer, and
the release layer faces each of the resin layer of the inner tubular part and the resin layer of the outer tubular part.

17. The racket frame according to claim 4, wherein each of the inner tubular part and the outer tubular part includes a resin layer, and
the release layer faces each of the resin layer of the inner tubular part and the resin layer of the outer tubular part.

18. The racket frame according to claim 5, wherein each of the inner tubular part and the outer tubular part includes a resin layer, and
the release layer faces each of the resin layer of the inner tubular part and the resin layer of the outer tubular part.

19. The racket frame according to claim 6, wherein each of the inner tubular part and the outer tubular part includes a resin layer, and
the release layer faces each of the resin layer of the inner tubular part and the resin layer of the outer tubular part.

20. The racket frame according to claim 7, wherein each of the inner tubular part and the outer tubular part includes a resin layer, and
the release layer faces each of the resin layer of the inner tubular part and the resin layer of the outer tubular part.
